(19) United States
(12) Patent Application Publication
(10) Pub. No.: US 2014/0286780 A1
(43) Pub. Date: Sep. 25, 2014

(54) AEROGENERATOR BLADE TIP SEGMENT AND METHOD OF ASSEMBLY

(71) Applicants: Phillips Antonio da Costa Lemos, Sorocaba (BR); Hely Ricardo Savii, Sorocaba (BR)

(72) Inventors: Phillips Antonio da Costa Lemos, Sorocaba (BR); Hely Ricardo Savii, Sorocaba (BR)

(73) Assignee: TECSIS TECNOLOGIA E SISTEMAS AVANCADOS S.A., Sorocaba (BR)

(21) Appl. No.: 14/237,012

(22) PCT Filed: Aug. 5, 2011
(86) PCT No.: PCT/IB2011/053518

§ 371 Date: Mar. 20, 2014

(51) Int. Cl. F03D 1/06; B23P 15/04

(52) U.S. Cl. CPC F03D 1/0675; B23P 15/04; F03D 1/0633
USPC 416/210 R; 29/889.71

(57) ABSTRACT

Provided is a method of assembling an aerogenerator blade tip segment. The method includes: removing an outboard tip end part of an aerogenerator blade; removing at least a portion of a leading edge panel and at least a portion of a trailing edge panel from a remaining outboard end of the aerogenerator blade, thus forming a body and a projection extending in a substantially longitudinal direction from an outboard end of the body, the projection having a spar cap portion and a shear web portion; removing a coating from an outer surface of the projection; attaching at least one reinforcement to the shear web portion of the projection; bonding a tip segment to the projection; and covering a joint between the body of the aerogenerator blade and the tip segment with an aerodynamic profile.

### TECHNICAL FIELD

This invention relates to aerogenerator blades and more particularly to methods for assembling an aerogenerator blade tip segment and a blade tip segment assembly.

### BACKGROUND ART

Wind power is frequently produced by large generators comprising a vertical structure (e.g. a tower) on top of which is placed at least one horizontal or vertical axis wind turbine that includes one, two, three or multiple rotor blades. Wind power generators, or simply ‘aerogenerators’, are designed to exploit wind energy existing at a particular location and therefore vary in height, control system, number of blades, blade orientation, shape and materials.

Blades of 20 to 40 meters in length may be used for an aerogenerator with a rated power of about 0.5 MW to about 1.5 MW are very common in commercial wind farms. However, even larger aerogenerator blades, which may have a length of more than 80 meters are currently under implementation. Nevertheless, both medium-sized blades and larger blades still have many design, manufacturing and maintenance problems.

For instance, in regard to maintenance problems, an aerogenerator blade under normal operation is exposed to several risk conditions that may cause damage to the blade, such as various dynamic and static strains, accidents with birds, and lightning discharges that usually occur at the tip of the blade. Therefore, the blade tip region may be the part of the blade most susceptible to damage. Thus, repairing the damaged blade parts or replacement thereof is often necessary. Furthermore, in some cases, it may be desirable to change the aerodynamic profile of the tip of the blades, for obtaining a better utilization of the wind conditions.

### DISCLOSURE OF INVENTION

### Technical Problem

In order to replace or extend the tip of the aerogenerator blades, some systems may suggest adopting modular blades, in which the blade is previously entirely designed to be suitable to receive a tip replacement or segment. However, this replacement solution is only applicable to blades originally designed to be modular. Other recent techniques suggest the use of complex systems with mechanical fasteners such as supporting rods, brackets or dowel pins. Such systems may be complex and costly, causing inconveniences in regard to manufacturing, installing and maintenance.

### Technical Solution

According to an aspect of an exemplary embodiment, a method of assembling an aerogenerator blade assembly is provided. The method includes: removing a tip end part from an outboard end of an aerogenerator blade; removing at least a portion of leading edge panel and at least a portion of a trailing edge panel from a remaining outboard end of the aerogenerator blade, such that a body and a blade projection is formed, the blade projection extending in a substantially longitudinal direction from the body and including a spar cap portion and a shear web portion; and attaching a tip segment to the blade projection.

The tip segment may include a tip portion and a tip projection, the tip projection comprising two tip spars, extending in a substantially lengthwise direction from the tip portion, and a shear web extending in the substantially lengthwise direction between the two tip spars. Attaching the tip segment to the blade projection may include: inserting the spar cap portion of the blade projection between the two tip spars of the tip projection; mechanically affixing the shear web of the tip projection to the shear web portion of the blade projection; and affixing an outer skin over a joint between the aerogenerator blade and the tip projection, thus providing an aerodynamic outer profile.

Attaching the tip segment to the blade projection may further include: attaching a fist end of a trailing edge reinforcement to a trailing edge of the body of the aerogenerator blade and attaching a second end of a trailing edge reinforcement to a trailing edge of the tip portion of the tip segment.

Prior to the attaching the tip segment to the blade projection, a coating may be removed from an outer surface of the projection; and at least one reinforcement may be attached to the shear web portion of the projection.

The tip segment may have a curved profile when viewed from a direction substantially perpendicular to a length of the aerogenerator blade.

A cross sectional profile of the tip segment may be different from a cross-sectional profile of the outboard end of the body of the aerogenerator blade, such that there is a step in the profile of the assembled aerogenerator blade tip segment at a joint between the aerogenerator blade and the tip segment.

Bonding the tip segment to the projection may include attaching an end of a lightning cable of the aerogenerator blade to a lightning cable in the tip segment.

A length of the aerogenerator blade prior to the removing the tip end part may be at least 35 meters, and a length of the tip segment may be at least 9% of the length of the aerogenerator blade prior to the removing the tip end part. The tip segment may include at least one projected shear web, and bonding the tip segment to the projection may include attaching the projected shear web of the tip segment to the shear web portion of the blade projection.

Attaching the projected shear web of the tip segment to the shear web portion of the projection may include attaching at least one mechanical fastener element to the shear web of the tip projection and the shear web portion of the blade projection.

According to an aspect of another exemplary embodiment, an aerogenerator blade assembly is provided. The assembly includes: an aerogenerator blade comprising a body and a blade projection, the blade projection extending in a substantially longitudinal direction from the body and having a spar cap portion and a shear web portion; a tip segment joined to the aerogenerator blade, the tip segment having a tip portion and a tip projection, the tip projection including two tip spars, extending in a substantially lengthwise direction from the tip portion and a shear web extending in the substantially lengthwise direction between the two tip spars; and an outer skin disposed over a joint between the aerogenerator blade and the tip segment, thus providing an aerodynamic outer profile. The spar cap portion of the blade projection may be disposed between the two tip spars of the tip projection, and the shear web of the tip projection may be mechanically fixed to the shear web portion of the blade projection.

A trailing edge reinforcement may include a first end attached to a trailing edge of the body of the aerogenerator blade and a second end attached to a trailing edge of the tip portion of the tip segment.

At least one reinforcement may be attached to the shear web portion of the blade projection.

The tip segment may have a curved profile when viewed from a direction substantially perpendicular to a length of the aerogenerator blade assembly.

A cross-sectional profile of the tip segment may be different from a cross-sectional profile of an outboard end of the body of the aerogenerator blade, such that there is a step in the profile of the aerogenerator blade assembly at the joint. Description of Drawings

The above and other exemplary aspects and/or advantages will become more apparent by describing in detail exemplary embodiments with reference to the accompanying drawings, which are not necessarily drawn on scale. In the drawings, some identical or nearly identical components that are illustrated in various figures may be represented by a corresponding numeral. For purposes of clarity, not every component may be labeled in every drawing.

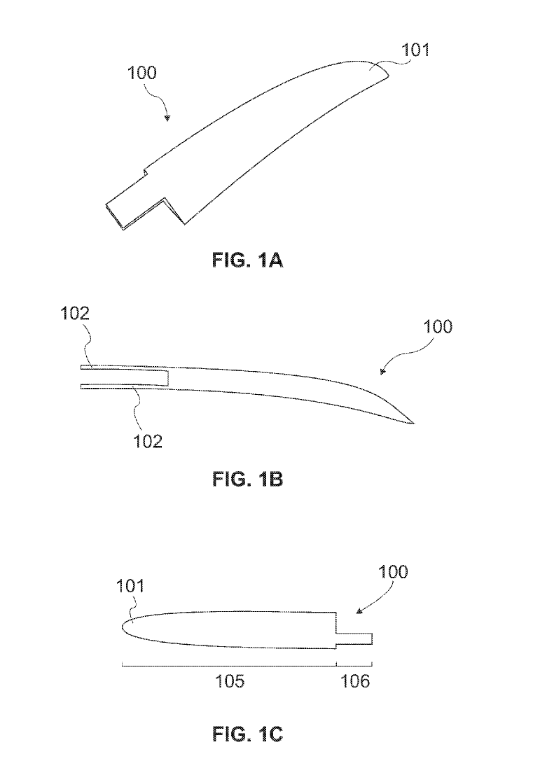

FIGS. 1A, 1B, and 1C illustrate a perspective view, a side view and a top view, respectively, of a tip segment according to an exemplary embodiment;

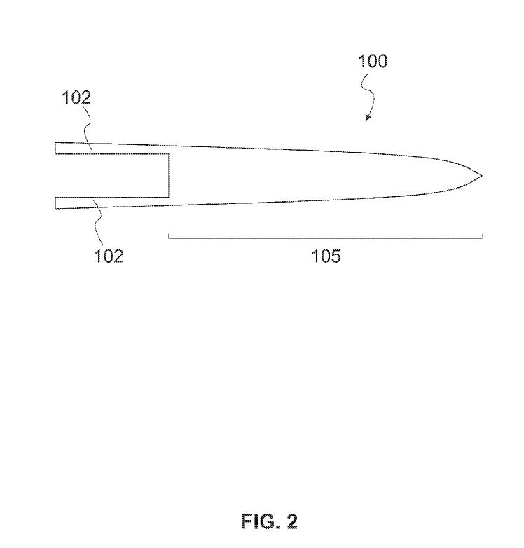

FIG. 2 illustrates a side view of a tip segment according to an exemplary embodiment;

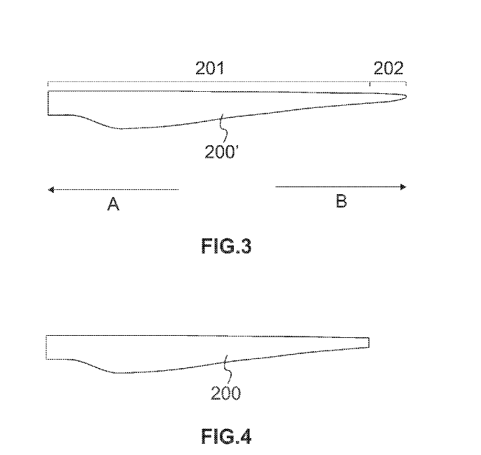

FIG. 3 illustrates an aerogenerator blade according to an exemplary embodiment;

FIG. 4 illustrates the aerogenerator blade of FIG. 3 with a tip end part removed;

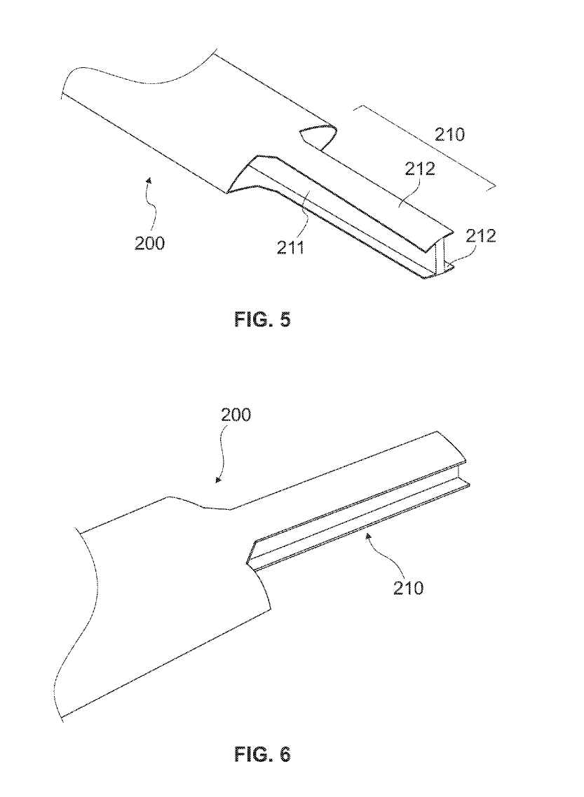

FIGS. 5 and 6 illustrate an aerogenerator blade with a projection according to an exemplary embodiment;

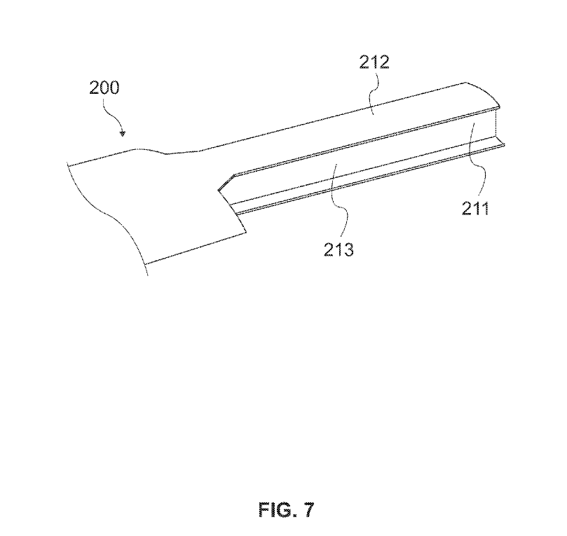

FIG. 7 illustrates an aerogenerator blade with a projection and reinforcements according to an exemplary embodiment;

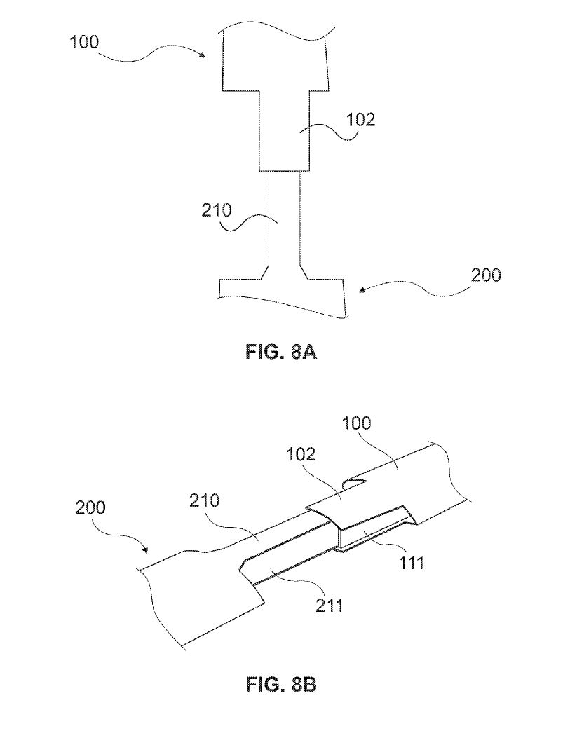

FIGS. 8A and 8B illustrate an attachment of an aerogenerator blade to a tip segment according to an exemplary embodiment;

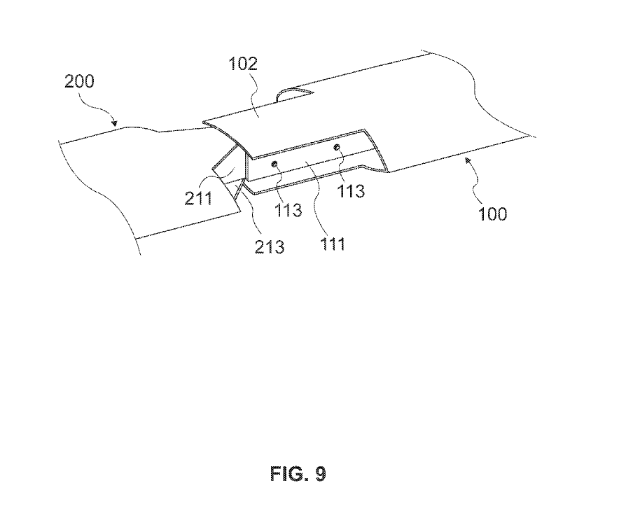

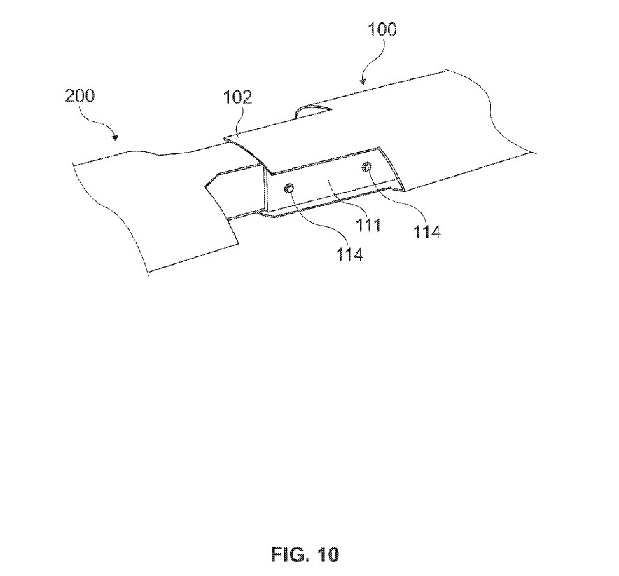

FIGS. 9 and 10 illustrate an attachment of an aerogenerator blade to a tip segment using holes and fasteners according to an exemplary embodiment;

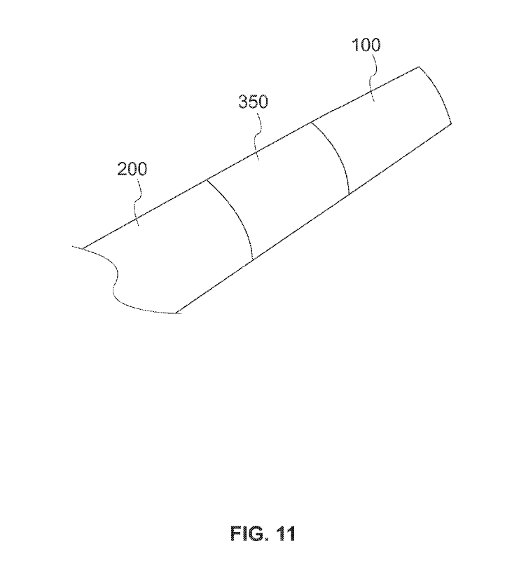

FIG. 11 illustrates an outer skin applied to a joint between an aerogenerator blade and a tip segment according to an exemplary embodiment;

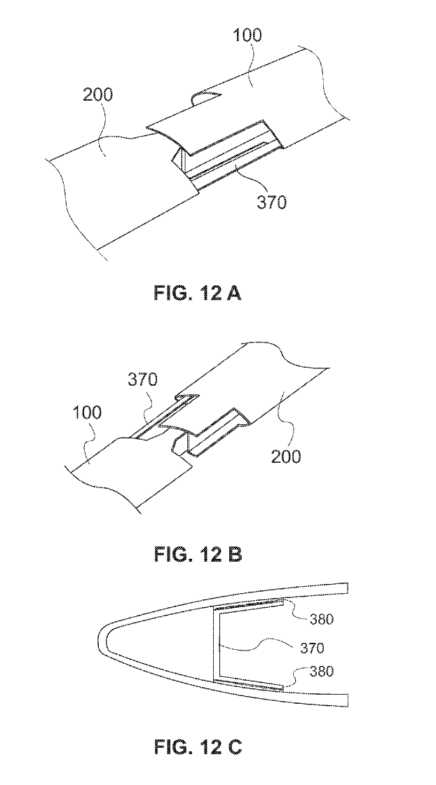

FIGS. 12A, 12B, and 12C illustrate the application of a trailing edge reinforcement according to an exemplary embodiment;

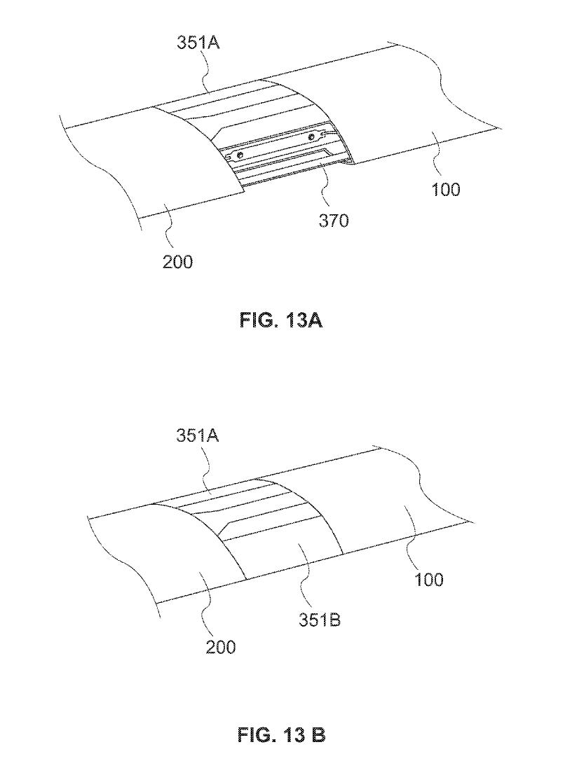

FIGS. 13A and 13B illustrate the application of fairings to a joint between anaero-generator blade and a tip segment according to an exemplary embodiment;

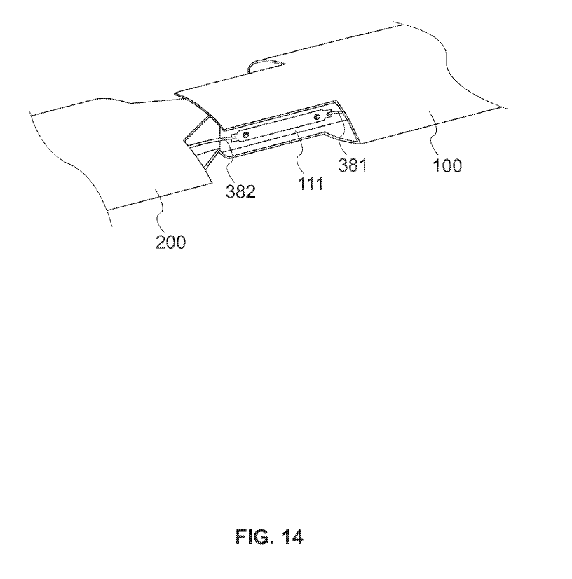

FIG. 14 illustrates a lightning projection attached between an aerogenerator blade and a tip segment according to an exemplary embodiment; and

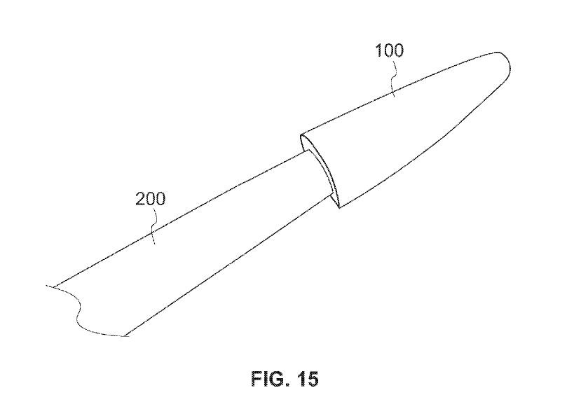

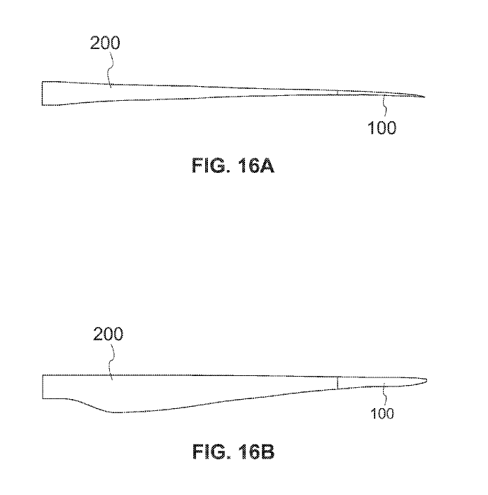

FIGS. 15, 16A and 16B illustrate a tip segment attached to an aerogenerator blade according to exemplary embodiments.

### MODE FOR INVENTION

Hereinafter, exemplary embodiments will be described with reference to the attached drawings. Like reference numerals in the drawings denote like elements.

While exemplary embodiments are described herein, they should not be construed as being limited to the specific descriptions set forth herein; rather, these embodiments are provided so that this disclosure will be thorough and complete. In the drawings, the sizes of components may be exaggerated or made smaller for purposes of clarity. The phraseology and terminology used herein is for the purpose of description and should not be regarded as limiting. The use of ‘including’, ‘comprising’, ‘having’, ‘containing’ or ‘involving’, and variations thereof used in this description, is meant to encompass the items listed thereafter and equivalents thereof as well as additional items. The dimensions as recited herein are merely exemplary and other dimensions may be used in conjunction with the exemplary embodiments as would be understood by one of skill in the art.

A pre-fabricated tip segment (100) according to an exemplary embodiment is shown in FIGS. 1A, 1B, and 1C. The tip segment (100) includes a tip portion (105) and a tip projection (106). The tip projection (106) includes projected tip spars (102) which extend in a substantially longitudinal direction away from the tip end (101) of the tip segment (100). The tip projection (106) may also include a web. The tip segment(100) may have a curved shape as shown in FIGS. 1A, 1B, and 1C, or may have other suitable aerodynamic profiles, such as a substantially straight shape, as shown in FIG. 2.

An original aerogenerator blade to which a tip segment (100) may be applied is shown in FIG. 3. The aerogenerator blade (200′) includes a body part (201) and a tip end part (202).

FIGS. 3-16 illustrate a method of assembling an aerogenerator blade tip segment (100) according to exemplary embodiments.

For assembling a tip segment (100) to an aerogenerator blade, an original aero-generator blade (200′) is provided. The aerogenerator blade (200′) may be provided in a vertical position with work to be done from a hanging platform.

FIG. 3 illustrates the original aerogenerator blade (200′). The original aerogenerator blade (200′) is cut to remove the tip end part (202) at the end of the aerogenerator blade in the outboard direction (e.g. to the right), as indicated by the arrow B in FIG. 3. The cutting may include using tooling to define a location for cutting. The tooling may be fixed to the aerogenerator blade and to the tip end part (202) for marking the cutting location, for cutting, or for both marking and cutting. Thus, the attached tooling may be removed between marking and cutting or after cutting. For instance, in an exemplary aerogenerator blade of about 37 metersin length, the tooling may be affixed to the aerogenerator blade (200′) at a distance of approximately 34 to 36 meters from an inboard end of the aerogenerator blade (200′) (e.g. a left end as shown in FIG. 3). The inboard direction is indicated by the arrow A in FIG. 3. The aerogenerator blade (200′) may be cut at a distance of approximately 36 meters from the inboard end of the blade (200′). After cutting, the tip end part (202) is removed. In an exemplary aero-generator blade of about 37 meters in length, the removed tip end part (202) may be approximately 1-2 meters long and weigh approximately 50 kg, depending the type of materials other particularities of the specific aerogenerator blade design.

After the tip end part (202) is removed, shell panel portions are removed from an end portion of the trimmed original aerogenerator blade (200), leaving a projection (210) at the outboard end of the aerogenerator blade (200), as shown in FIG. 5. In an exemplary aerogenerator blade having a length of about 37 meters, the blade shells are cut chordwise at a distance which may be approximately 34 meters from the inboard end of the aerogenerator blade (200) and are cut spanwise at a distance which may be approximately 36 meters from the inboard end of the aerogenerator blade (200). This cutting then leaves the original blade cap and approximately 20 millimeters of shell on each side of the original blade cap. Tooling may be used for this cutting, and if used, is removed after cutting. After cutting, the aerogenerator blade (200) includes a projection (210).

Surfaces of the aerogenerator blade (200) and the projection (210) are then prepared for gluing, as shown in FIG. 6. The preparation may include removing external surfaces of the projection (210). The external surfaces of an outboard end of the aero-generator blade (200) adjacent to the projection (210) may also be removed. In an exemplary blade having a length of about 37 meters, the removal may be performed from a distance of approximately 33.9 meters from the inboard end of the aero-generator blade (200). The removal may be performed by grinding the external surfaces. Excess adhesive at the sides of the web (211) may also be removed. This will provide space for reinforcements, described below.

If the aerogenerator blade (200) includes a lightning cable, the lightning cable is removed from the side of the shear web along the projection (210), and a connector is attached to the outboard end of the lightning cable. The joint impedance can be verified at this time.

After the shell panels are removed and any surface preparations are completed, shear web reinforcements (213) may be attached and bonded to the shear web (211) as shown in FIG. 7. The position of the reinforcements (213) may be determined by measuring, as with a measuring tape. In an exemplary embodiment, two or four reinforcements (213) may be used, one or two on each side of the shear web (211), and the reinforcements (213) may be attached by applying adhesive between the shear web sides (211) and the reinforcements (213). The exemplary ‘I-beam’ section shown in FIGS. 5, 6 and 7 may be appropriately designed with other suitable configurations.

FIGS. 8A and 8B illustrate the bonding of the tip segment (100) to the projection (210) of the aerogenerator blade (200). Adhesive may be applied along the spar caps of the projection (210). In an exemplary blade having a length of about 37 meters, the adhesive may be applied from a distance of approximately 34.5 meters to approximately 36 meters from the inboard end of the aerogenerator blade (200). The tip segment (100) is then attached such that the projection (210) of the aerogenerator blade (200) is inserted between the spars (102) of the tip segment (100). In an exemplary embodiment, the tip segment (100) may be approximately 5.25 meters and may weigh approximately 100 kg. The position of the tip segment (100) when attached to the aero-generator blade (200) may be fixed by a panel internal to the tip segment (100) that will contact with the tip spar cap. A length of the aerogenerator blade (200) prior to the removing the tip end part (202) may be at least 35 meters, and a length of the tip segment (100) may be at least 9% of the length of the aerogenerator blade (200) prior to the removing the tip end part (202).

The tip segment (100) may be fixed in place, with appropriate methods for assisting bonding and curing of composite materials.

As shown in FIG. 9, holes may be drilled through the projection (210) of the blade (200) using pilot holes (113) in the tip segment (100) web (111). Each of the holes may be approximately 8-10 mm in diameter. As shown in FIG. 10, fasteners (114) are then attached through the holes. The fasteners (114) may be bolts which are secured with nuts. Bolt bushings may also be used.

As shown in FIG. 11, after the blade projection (210) and the tip segment (100) are attached to each other, a skin (350) may be applied over the joint.

According to an aspect of an exemplary embodiment, a trailing edge reinforcement (370) may be used to strengthen the joint as shown in FIG. 12A, 12B, and 12C. The trailing edge reinforcement (370) may be inserted and affixed with adhesive (380).

The bonding of the skin as shown in FIG. 11 may include applying two panels of joint fairings (351A) and (351B) as shown in FIGS. 13A and 13B. A fairing on each side of the aerogenerator blade (200) may be attached by adhesive and cured by appropriate techniques. The joint may then be finished by removing excess adhesive, applying a finishing paste, and painting the joint area.

According to an aspect of another exemplary embodiment, a lightning projection (381) in the tip segment (100) may be attached to the end of the lightning cable (382) in the blade side of the joint, as shown in FIG. 14.

As shown in FIG. 15, the tip segment (100) may have a different cross-sectional profile than the end of the aerogenerator blade (200). For example, the tip segment (100) may have an aerodynamic profile, length and/or a chord and thickness ratio different from that of the end of the aerogenerator blade (200). Other suitable profiles may also be used, and thus the tip segment may be designed for instance as blade tip segment with twisted and/or winglet profile.

FIGS. 16A and 16B illustrate an exemplary aerogenerator blade including a fully-assembled tip segment (100).

While exemplary embodiments have been particularly shown and described, various changes in form and details may be made therein by a person skilled in the art. Such changes and other equivalents are also intended to be encompassed by the following claims.

1. A method of assembling an aerogenerator blade assembly, the method comprising:
removing a tip end part from an outboard end of an aerogenerator blade;
removing at least a portion of leading edge panel and at least a portion of a trailing edge panel from a remaining outboard end of the aero-generator blade, such that a body and a blade projection is formed, the blade projection extending in a substantially longitudinal direction from the body and comprising a spar cap portion and a shear web portion; and
attaching a tip segment to the blade projection.

2. The method of claim 1, wherein:
the tip segment comprises a tip portion and a tip projection, the tip projection comprising two tip spars, extending in a substantially lengthwise direction from the tip portion, and a shear web extending in the substantially lengthwise direction between the two tip spars; and
the attaching the tip segment to the blade projection comprises:
inserting the spar cap portion of the blade projection between the two tip spars of the tip projection;
mechanically affixing the shear web of the tip projection to the shear web portion of the blade projection;
affixing an outer skin over a joint between the aerogenerator blade and the tip projection, thus providing an aerodynamic outer profile.

3. The method of claim 2, wherein the attaching the tip segment to the blade projection further comprises:
attaching a first end of a trailing edge reinforcement to a trailing edge of the body of the aerogenerator blade and attaching a second end of a trailing edge reinforcement to a trailing edge of the tip portion of the tip segment.

4. The method of claim 1, further comprising:
prior to the attaching the tip segment to the blade projection, removing a coating from an outer surface of the projection; and attaching at least one reinforcement to the shear web portion of the projection.

5. The method of claim 1 wherein the tip segment has a curved profile when viewed from a direction substantially perpendicular to a length of the aerogenerator blade.

6. The method of claim 1, wherein a cross sectional profile of the tip segment is different from a cross-sectional profile of the outboard end of the body of the aerogenerator blade, such that there is a step in the profile of the assembled blade tip segment at a joint between the aero-generator blade and the tip segment.

7. The method of claim 1, wherein the bonding the tip segment to the projection comprises attaching an end of a lightning cable of the aero-generator blade to a lightning cable in the tip segment.

8. The method of claim 1, wherein a length of the aerogenerator blade prior to the removing the tip end part is at least 35 meters, and a length of the tip segment is at least 9% of the length of the aerogenerator blade prior to the removing the tip end part.

9. The method of claim 1, wherein:
the tip segment comprises at least one projected shear web; and
the bonding the tip segment to the projection comprises attaching the projected shear web of the tip segment to the shear web portion of the blade projection.

10. The method of claim 9, wherein the attaching the projected shear web of the tip segment to the shear web portion of the projection comprises attaching at least one mechanical fastener element to the shear web of the tip projection and the shear web portion of the blade projection.

11. The method of claim 1 wherein the tip segment has a twisted or winglet aerodynamic profile.

12. An aerogenerator blade assembly comprising:
an aerogenerator blade comprising a body and a blade projection, the blade projection extending in a substantially longitudinal direction from the body and comprising a spar cap portion and a shear web portion;
a tip segment joined to the aerogenerator blade, the tip segment comprising a tip portion and a tip projection, the tip projection comprising two tip spars, extending in a substantially lengthwise direction from the tip portion and a shear web extending in the substantially lengthwise direction between the two tip spars; and
an outer skin disposed over a joint between the aerogenerator blade and the tip segment, thus providing an aerodynamic outer profile;
wherein the spar cap portion of the blade projection is disposed between the two tip spars of the tip projection, and the shear web of the tip projection is mechanically fixed to the shear web portion of the blade projection.

13. The assembly of claim 12, further comprising:
a trailing edge reinforcement comprising a first end attached to a trailing edge of the body of the aerogenerator blade and a second end attached to a trailing edge of the tip portion of the tip segment.

14. The assembly of claim 12, further comprising:
at least one reinforcement attached to the shear web portion of the blade projection.

15. The assembly of claim 12, wherein the tip segment has a curved profile when viewed from a direction substantially perpendicular to a length of the aerogenerator blade assembly.

16. The assembly of claim 12, wherein a cross-sectional profile of the tip segment is different from a cross-sectional profile of an outboard end of the body of the aerogenerator blade, such that there is a step in the profile of the blade assembly at the joint.

17. The assembly of claim 12, wherein the tip segment has a twisted or winglet aerodynamic profile.

18. The assembly of claim 12, wherein a length of the aerogenerator blade prior to the removing the tip end part is at least 35 meters, and a length of the tip segment is at least 9% of the length of the aero-generator blade prior to the removing the tip end part.
